(19) United States
(12) Patent Application Publication
(10) Pub. No.: US 2009/0264276 A1
(43) Pub. Date: Oct. 22, 2009

(54) Production method of dielectric particles

(75) Inventors: Tomohiro Yamashita, Tokyo (JP); Tomoaki Nonaka, Tokyo (JP); Shinsuke Hashimoto, Tokyo (JP); Hiroshi Sasaki, Tokyo (JP); Yoshinori Fujikawa, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/385,607

(22) Filed: Apr. 14, 2009

(30) Foreign Application Priority Data
Apr. 17, 2008 (JP) 2008-107693

(51) Int. Cl. C04B 35/468

(52) U.S. Cl. 501/138

(57) ABSTRACT

A method of producing fine and uniform barium titanate particles having high crystallinity by performing a heat treatment on titanium dioxide and barium carbonate having a specific surface area of at least 20 m²/g and low rutile ratio; comprising the steps of preparing mixed powder by mixing titanium dioxide particles having a rutile ratio of 30% or lower and a specific surface area of 20 m²/g or more and barium carbonate particles, a first heat treatment step for performing a heat treatment on the mixed powder to generate a barium titanate phase having an average thickness of at least 3 nm continuously on surfaces of titanium dioxide particles by an amount of 15 wt % or more, and a second heat treatment step for performing a heat treatment at 800° C. to 1000° C.

### BACKGROUND OF THE INVENTION

1. Field of the Invention

The present invention relates to a production method of dielectric particles, typically barium titanate particles.

2. Description of the Related Art

Ceramics, such as BaTiO₃, (Ba, Sr)TiO₃, (Ba, Ca)TiO₃, (Ba, Sr) (Ti, Zr)O₃ and (Ba, Ca) (Ti, Zr)O₃, are widely used for dielectric of ceramic capacitors. A dielectric layer is obtained by preparing a green sheet from paste containing dielectric particles and sintering the green sheet. The dielectric particles to be used for such a purpose are generally produced by solid-phase synthesis. In the case of barium titanate (BaTiO₃), barium carbonate (BaCO₃) particles and titanium dioxide (TiO₂) particles are wet mixed and dried, then, a heat treatment (calcination) at a temperature of about 900 to 1200° C. is performed on the mixed powder to bring a solid-phase chemical reaction between the barium carbonate particles and titanium dioxide particles, thereby, barium titanate particles are obtained. When synthesizing (Ba, Sr)TiO₃, (Ba, Ca)TiO₃, (Ba, Sr) (Ti, Zr)O₃ and (Ba, Ca) (Ti, Zr)O₃, etc., a compound to be a Sr source, Ca source or Zr source is added at the time of the solid-phase reaction or a compound to be a Sr source, Ca source or Zr source is added after synthesizing the barium titanate and a heat treatment (firing) is furthermore performed.

Along with a ceramic layer between internal electrodes becoming thinner, barium titanate particles to be used as ceramic material particles for obtaining dielectric for multilayer ceramic capacitors are required to be fine particles having uniform particle size (expressed by the diameter) and high tetragonality.

In the solid-phase reaction, highly-pure titanium dioxide obtained by pyrolyzing titanium tetrachloride is typically used so as not to deteriorate characteristics of dielectric ceramics to be obtained. In this case, a crystal form of the thus obtained titanium dioxide varies depending on the pyrolyzing condition. When a normal heat treatment condition is applied, the rutile ratio becomes high and a rutile type is generally dominant.

However, rutile type titanium dioxide particles have poor reactivity and tetragonality becomes low in the obtained barium titanium. If tetragonality of barium titanate is low, for example, when it is used as material particles of dielectric for a multilayer ceramic capacitor, solid dispersion of additive components added to the material particles into barium titanate easily proceeds in the firing step, therefore, a sintered body having a core-shell structure is hard to be obtained after the firing, which leads to a disadvantage that temperature characteristics of electric capacitance of the obtained multilayer ceramic capacitor become poor.

Also, even though tetragonality of barium titanate is high, if a primary particle size of the material particles is large, reliability of the multilayer ceramic capacitor declines when the dielectric ceramic layer is made thinner. When making layers thinner, not only a size of the primary particle size of the material particles but the distribution thereof also becomes an important factor, so that high crystallinity and preferable particle size distribution of barium titanate are necessary.

To improve tetragonality of barium titanate, in the solid-phase reaction method, it is effective to mix a barium compound, such as barium carbonate, with titanium dioxide, perform a heat treatment and set a heat treatment temperature high when synthesizing barium titanate. However, heightening of the heat treatment temperature leads to particle growth and particle aggregation, so that a disadvantage arises that it becomes harder to obtain finer barium titanate particles. Therefore, the obtained barium titanate was pulverized to be used (Patent Article 1). However, when obtaining finer particles by pulverizing barium titanate having high crystallinity, for example, when obtaining finer particles by wet pulverizing, ununiformity at the time of pulverizing also becomes an affecting factor in addition to the particle size distribution before pulverizing. Therefore, uniformly-sized particle is hard to obtain and it is also difficult to prevent deterioration of dielectric characteristics due to damages caused by the pulverization.

To eliminate the above disadvantages, there has been disclosed a method of producing barium titanate by using highly reactive titanium dioxide particles having a low rutile ratio (having high anatase ratio): wherein a barium compound that generates barium oxide by thermolysis is mixed with titanium dioxide having a rutile ratio of 30% or lower measured by the X-ray diffraction method and a specific surface area of 5 m²/g or larger measured by the BET method, and a heat treatment (calcination) is performed thereon (Patent Article 2).

According to this method, because highly reactive anatase type titanium dioxide as fine particles is used, it is possible to obtain barium titanate particles having high tetragonality and a small particle size. It is known that since anatase type titanium dioxide is in a metastable state against rutile type, it normally changes to be rutile type around 700° C.

In recent years, however, electronic devices have rapidly become smaller and multilayer ceramic capacitors are also required to have further thinner dielectric layers. Consequently, barium titanate particles is also required to be furthermore finer and to have a uniform particle size.

In the method of Patent Article 2, a heat treatment of the mixed powder is performed at a high temperature of 950° C. or higher in one stage. Under such a firing condition, before being brought to a reaction, particle growth arises in barium compound particle and titanium dioxide particles as materials, therefore, there is a limit to make the barium titanate particles finer. In the case of titanium dioxide particles having relatively large particles, wherein specific surface area is 5 to 10 m²/g, even if subjected to a heat treatment at 700 to 800° C., a remarkable decline of the specific surface area due to particle growth does not occur; however, in the case of those having a specific surface area of 20 m²/g or larger, the specific surface area remarkably declines at 700° C. or higher, which is a problem. This tells that, due to the large specific surface area, the particle surface energy is high and that induces the particle growth and combining of particles (necking between adjacent particles) even around 700° C.

Also, formation reaction of barium titanate using barium carbonate and titanium dioxide as materials is generally expressed by BaCO₃+TiO₂→BaTiO₃+CO₂, and it is known that the reaction takes two stages (Non-patent Article 1). Namely, the first-stage reaction is formation reaction of barium titanate on particle surfaces of the titanium dioxide particles (contact points of barium carbonate and titanium dioxide) at 500 to 700° C. The second-stage reaction is, in the product of the first stage, dispersion of barium ion in titanium dioxide at a temperature of 700° C. or higher. It is necessary for the reaction on the particle surfaces of titanium dioxide particles that the material particles are sufficiently mixed and dispersed. In the Non-patent Article 1, a material having a specific surface area of 26.5 m²/g is used, and it describes the fact that behaviors of thermogravimetric analysis and differential thermal analysis differ largely in accordance with time of mixing and dispersing. Accordingly, it indicates that, when the titanium dioxide particles are fine particles of 20 m²/g or larger, aggregation of titanium dioxide particles easily occurs, so that characteristics and a particle size distribution of the resulting barium titanate are largely affected by the dispersion condition.

Therefore, as described in Patent Article 2, when a heat treatment of the mixed powder is performed at a temperature of 950° C. in one stage, particle growth of material particles, barium titanate formation reaction on the surfaces of titanium dioxide particles, dispersion of barium ion and particle growth of barium titanate particles, etc. occur in a short time. As a result, particle morphology become uneven in the resulting barium titanate particles.

When using barium carbonate as a material, it comes under the influence of carbon dioxide (CO₂) generated in the reaction process, so that when performing a heat treatment on a large amount of mixed powder (for example, 1 kg or more), the influence of carbon dioxide to be generated cannot be ignored.

In the related art, for example in the Patent Article 2, it is known that crystallinity improves by performing a heat treatment under reduced pressure. However, when using barium carbonate as a material, it is necessary to continuously take out carbon dioxide generated in the reaction process, so that a large facility is necessary.

### [Patent Article 1] The Japanese Unexamined Publication No. 2001-345230

### [Patent Article 2] The Japanese Unexamined Publication No. 2002-255552

[Non-patent Article] J. Mater. Rev. 19, 3592 (2004)

### SUMMARY OF THE INVENTION

An object of the present invention is to provide a method of producing fine dielectric particles, particularly barium titanate particles, having a uniform particle size by using highly reactive fine titanium dioxide particles having a low rutile ratio (high anatase ratio).

The present inventors have earnestly studied to attaining the above object, and found that, by uniformly growing a barium titanate phase generated continuously on the surfaces of titanium dioxide particles to a certain degree and, then, performing a heat treatment at a high temperature, particle growth of the titanium dioxide particles as a material and barium titanate particles as the product can be suppressed in the heat treatment, and barium titanate particles having uniform particle morphology and high crystallinity can be obtained. Based on the knowledge, the present inventors reached to invent the production method explained below.

The present invention for attaining the above object comprises the following subject matters.

A production method of dielectric particles; comprising the steps of:

preparing titanate dioxide particles having a rutile ratio of 30% or lower and a BET specific surface area of 20 m²/g or more;

preparing barium carbonate particles having a BET specific surface area of 10 m²/g or more;

preparing mixed powder by mixing titanate dioxide particles and barium carbonate particles;

performing a first heat treatment step for performing a heat treatment on the mixed powder to generate a barium titanate phase on surfaces of titanate dioxide particles; and

performing a second heat treatment step for performing a heat treatment at 800° C. to 1000° C. after the first heat treatment step,

wherein a heat treatment temperature in the first heat treatment step is lower than a heat treatment temperature in the second heat treatment step, and a sufficient time is secured for a reaction to convert at least 15 wt % of mixed powder after the first heat to barium titanate and generating a barium titanate phase having an average thickness of at least 3 nm on surfaces of titanate dioxide particles

Preferably, the first heat treatment step is a step for generating a barium titanate phase having an average thickness of at least 4 nm continuously on surfaces of the titanate dioxide particles in at least 75% of the total titanate dioxide particles, and at least 20 wt % of the mixed powder becomes barium titanate.

Preferably, a heat treatment temperature in the second heat treatment step is 850° C. to 950° C., and a c/a value of barium titanate particles to be generated is 1.008 or larger.

Preferably, a heat treatment temperature in the second heat treatment step is 850° C. to 950° C., and, in the resulting barium titanate particles, ratio (I₍₂₀₀₎/I_{b}) of X-ray intensity (I_{b}) at a midpoint of peak point assigned to the (200) plane and a peak point assigned to the (002) plane, to diffraction ray intensity I₍₂₀₀₎ assigned to the (200) plane is 4 or higher, measured by powder X-ray diffraction using an X-ray CuKα radiation.

Preferably, the first heat treatment step is performed under a pressure between 1×10³ and 1.0133×10⁵ Pa at a temperature of 575° C. to 650° C. in the air, and 25 wt % or more but not more than 55 wt % of the mixed powder becomes barium titanate.

Preferably, the first heat treatment step is performed under a pressure between 1×10³ and 1.0133×10⁵ Pa at a temperature of 600° C. to 700° C. in the air by using a firing furnace for firing powder substance while fluidizing it, and 20 wt % or more but not more than 75 wt % of the mixed powder becomes barium titanate.

Preferably, a CO₂ gas concentration in the atmosphere is controlled to 15 mole % or lower in the first heat treatment step.

Preferably, a step of cooling to 550° C. is performed after the first heat treatment step and before performing the second heat treatment step.

Alternately, the first heat treatment step may be performed under a pressure of 1×10³ Pa or lower at a temperature of 450° C. to 600° C.

Preferably, a step for confirming progress of the first heat treatment step is further included, wherein weight concentration of a barium titanate phase is evaluated by conducting a powder X-ray diffraction analysis on a product of the first heat treatment step.

Preferably, a step for confirming progress of the first heat treatment step is further included, said step of comprises observing a product of the first heat treatment step through a transmission electron microscope analysis, and confirming a barium titanate phase on surfaces of titanate dioxide particles.

According to the present invention, particle growth is suppressed when producing barium titanate and it is possible to obtain fine barium titanate particles having a uniform particle morphology, preferable tetragonality and high crystallinity.

It is not to constrain theoretically, but the present inventors consider that the above effects are outcomes of reaction mechanisms explained below.

Namely, by growing a barium titanate phase continuously on surfaces of titanium dioxide particles to a certain degree in the first heat treatment step, direct contact between titanium dioxide particles can be suppressed in the first heat treatment step and steps after that. As a result, particle growth (necking, particle combining) of titanium dioxide particles is suppressed and generation of intermediate substance (Ba₂TiO₄) as an impurity caused by ununiformity of the reaction is reduced. The Non-patent Article 1 describes that the barium titanate phase generated on the surfaces in the first step is not a continuous surface layer but a non-continuous fine particle state, while the present invention can realize formation of a continuous barium titanate phase on the surfaces.

In the first heat treatment step of the present invention, it is possible to generate a barium titanate phase having an average thickness of 4 nm or more continuously on surfaces of at least 75% of the total titanium dioxide particles. At this time, it is confirmed by using a powder X-ray diffraction analysis that at least 20 wt % of the mixed powder becomes barium titanate, and the barium titanate phase on the surfaces can be confirmed by using a transmission electron microscopy analysis.

Next, in the second heat treatment step, barium ion is dispersed to expand the barium titanate phase and, finally, barium titanate particles are obtained. This step is performed in a relatively high temperature. When a barium titanate phase is not formed sufficiently on the surfaces of the titanium dioxide particles, necking and particle combining through from exposed titanium dioxide parts and irregularly-shaped particle growth may be caused. In that case, the resulting barium titanate particles also become irregular in shape, and uniform barium titanate particles cannot be obtained. In this invention, however, since surfaces of titanium dioxide particles are covered with a barium titanate phase, dispersion of barium ion is performed without causing particle growth of titanium dioxide. As a result, fine barium titanate particles having uniform particle morphology can be obtained. Due to the effect of the first heat treatment step that a uniform barium titanate phase is formed on the surfaces, an intermediate product, such as Ba₂TiO₄, is not observed in the second heat treatment step, and an improvement of crystallinity of barium titanate (BaTiO₃) is exhibited around 850 to 900° C. and higher. Furthermore, those having high crystallinity can be generated even not under a reduced pressure of, for example, 1×10² Pa or less.

Furthermore, since the resulting barium titanate particles are fine particles, it is possible to grow the particles to a desired size through the second heat treatment step. As a result that a heat treatment is furthermore performed in the particle growth step, it is possible to obtain barium titanate particles having high tetragonality and high crystallinity.

### BRIEF DESCRIPTION OF DRAWINGS

These and other objects and features of the present invention will become clearer from the following description of the preferred embodiments given with reference to the attached drawings, in which:

FIG. 1A is an image of powder after the first heat treatment step through a transmission microscope (a TEM image by magnification of 600,000);

FIG. 1B is an EDS mapping of powder after the first heat treatment step by a Ti—K ray through a transmission microscope;

FIG. 1C is an EDS mapping of powder after the first heat treatment step by the Ba-L ray through a transmission microscope;

FIG. 1D is a STEM-Z contrast image of powder after the first heat treatment step through a transmission microscope;

FIG. 2 shows a relationship between a treatment temperature (T₀) in the first heat treatment step and a barium titanate production rate (production ratio);

FIG. 3 shows a relationship between a holding time in the first heat treatment (650° C.) and a barium titanate production rate;

FIG. 4 shows a relationship between a thickness of barium titanate on surfaces and a barium titanate production rate;

FIG. 5 shows X-ray diffraction results of a diffraction lines of (200) and (002), based on which ratios (I₍₂₀₀₎/I_{b}) in Example 1B-2, Example 3B-2, Comparative Example 1B-1 and Comparative Example 3B-2 are calculated;

FIG. 6 shows a relationship between a second heat treatment temperature (T₁) and a K-value;

FIG. 7 shows a relationship between a second heat treatment temperature (T₁) and a c/a value;

FIG. 8 shows a relationship between the K-value and a particle size (XRD);

FIG. 9 shows a relationship between a K-value of barium titanate particles when the second heat treatment temperature (T₁) is 925° C. and a first heat treatment temperature (T₀);

FIG. 10 shows a relationship between a c/a value of barium titanate particles when the second heat treatment temperature (T₁) is 925° C. and a first heat treatment temperature (T₀);

FIG. 11 shows a relationship between a K-value of barium titanate particles when the second heat treatment temperature (T₁) is 950° C. and a first heat treatment temperature (T₀);

FIG. 12 shows a relationship between a second heat treatment temperature (T₁) and a K-value of barium titanate particles obtained in Comparative Example 1B and Examples 4B to 6B;

FIG. 13 shows a relationship between a second heat treatment temperature (T₁) and a c/a value of barium titanate particles obtained in the Comparative Example 1B and Examples 4B to 6B;

FIG. 14 shows temperature dependency of a specific permittivity ∈r in dielectric characteristic evaluation samples obtained by using the barium titanate particles of Example 1B-1, Example 1B-2 and Comparative Example 1B-3;

FIG. 15 shows temperature dependency of a dielectric loss tan δ in dielectric characteristic evaluation samples obtained by using the barium titanate particles of Example 1B-1, Example 1B-2 and Comparative Example 1B-3.

### DESCRIPTION OF THE PREFERRED EMBODIMENT

Below, the present invention will be explained furthermore specifically with referring the best embodiments thereof. In the explanations below, an example of producing barium titanate as dielectric powder is taken, however, the present invention can be applied to production methods of a variety of dielectric particles having a step of performing a heat treatment on mixed powder including titanium dioxide particles and barium compound particles, such as (Ba, Sr)TiO₃, (Ba, Ca)TiO₃, (Ba, Sr) (Ti, Zr)O₃ and (Ba, Ca)(Ti, Zr)O₃.

A method of producing barium titanate of the present invention comprises a step of performing a heat treatment on mixed powder of titanium dioxide particles and barium compound particles.

A rutile ratio of titanium dioxide particles to be used as the material is 30% or lower, preferably 20% or lower and furthermore preferably 10% or lower. In terms of improving the reactivity, the lower the rutile ratio of the titanium dioxide particles, that is, the higher the anatase ratio is, the more preferable. However, in attaining the object of the present invention, an excessive lowering of the rutile ratio does not lead significant difference in the effects. Accordingly, in terms of improving the productivity, it is preferable to keep it around 10%. The rutile ratio is measured by an X-ray diffraction analysis of titanium dioxide particles.

A BET specific surface area of titanium dioxide particles is 20 m²/g or larger, preferably 30 m²/g or larger, and furthermore preferably 40 m²/g or larger. In terms of improving the reactivity and obtaining fine barium titanate particles, the larger the BET specific surface area of titanium dioxide particles, that is, the smaller the particle size of the particles is, the more preferable. However, when titanium dioxide particles are made excessively finer, the handleability may decline. Accordingly, in terms of improving the productivity, around 20 to 40 m²/g is preferable.

A production method of titanium dioxide particles to be used in the present invention is not particularly limited as far as the material properties explained above are satisfied, and commercially available titanium dioxide particles or those obtained by pulverizing the commercially available titanium dioxide particles may be used. Particularly, titanium dioxide particles obtained by a gas phase method using titanium tetrachloride as the material is preferably used because fine titanium dioxide particles having a low rutile ratio can be obtained.

A general production method of titanium dioxide by using a gas phase method is well known, and when titanium tetrachloride as a material is oxidized by using an oxidized gas, such as oxygen or steam, under a reaction condition of about 600 to 1200° C., fine titanium dioxide particles can be obtained. When the reaction temperature is too high, it is liable that an amount of titanium dioxide having a high rutile ratio increases. Accordingly, it is preferable that the reaction is conducted around 1000° C. or lower.

Titanium dioxide particles to be used as a material has a residual chlorine amount of preferably 1200 ppm or smaller, more preferably 600 ppm or smaller, and furthermore preferably 300 ppm or smaller. The smaller the residual chlorine amount is, the more preferable. However, when heating in order to lessen the chlorine, sintering between titanium dioxide particles and conversion to the rutile type occur. Therefore, it is preferable to keep it to an extent of 600 ppm or so when lessening the chlorine amount.

A content of each of Fe, Al, Si and S in the titanium dioxide particles is preferably 0.01 wt % or smaller. When each content of Fe, Al, Si and S exceeds 0.01 wt %, not only the mixing ratio of titanium dioxide and a barium source deviates, but also there is a possibility that the dielectric characteristics may be largely affected thereby. The smallest value is not limited, but 0.0001 wt % or larger is preferable in terms of the production costs.

Also, a particle size distribution of titanium dioxide particles is preferably uniform. Since the significant effect in the present invention is realization of barium titanate having uniform particle size while keeping a preferable particle size distribution of titanium dioxide; the more uniform the particle size distribution of the material is, the higher effect can be expected. Specifically, when indicating the particle size distribution of titanium dioxide as a material by a ratio of ((D90−D10)/D50), 0.5 to 2.0 is preferable, 1.5 or smaller is more preferable, and 1.0 or smaller is particularly preferable. For example, in titanium dioxide particles obtained by a gas phase method using titanium tetrachloride as a material, it is possible to generate fine particles having a specific surface area of 30 m²/g and a value (D90−D10)/D50 of 1.0. Note that a D10 diameter, D50 diameter and D90 diameter respectively mean particle diameters in accumulation 10%, accumulation 50% and accumulation 90% from the finer powder side of the cumulative particle size distribution and is evaluated by using a laser diffraction scattering method.

Barium carbonate is preferable as barium compound particles as a material. The barium carbonate particles are not particularly limited and well-known barium carbonate particles is may be used. However, to promote mixing dispersion and solid phase reaction to thereby obtaining fine barium titanate particles, it is preferable to use material particles having a relatively small particle size. Therefore, the BET specific surface area of barium compound particles to be used as a material is 10 m²/g or larger, preferably 10 to 40 m²/g, and more preferably 20 to 40 m²/g.

By using as material particles the specific titanium dioxide particles and barium carbonate particles as explained above, the solid phase reaction is promoted. Consequently, the heat treatment temperature can be lowered and the heat treatment time can be reduced, so that the energy cost can be reduced. Furthermore, by performing the first and second heat treatment steps as explained below with using the above materials, unevenness of particle growth at the time of the heat treatments can be suppressed, so that it is possible to obtain barium titanate particles having a small particle size and uniform particle morphology. Furthermore, the resulting fine barium titanate particles grow by continuing the heat treatment, with suitably setting the second heat treatment time, it is also possible to obtain barium titanate particles having a desired particle size and high crystallinity easily.

The ratio of barium carbonate particles and titanium dioxide particles in the mixed powder may be close to a stoichiomatric ratio capable of generating barium titanate. Therefore, Ba/Ti (mole ratio) in the mixed powder may be 0.990 to 1.010. When the Ba/Ti exceeds 1.010, barium carbonate may remain unreacted, while when less than 0.990, a hetero-phase including Ti may be generated in some cases.

A fabrication method of the mixed powder is not particularly limited and a normal method, such as a wet method using a ball mill, may be applied. After drying the obtained mixed powder, a heat treatment is performed to obtain barium titanate particles. Note that, as described in the Non-patent Article 1, it is necessary to eliminate the aggregations of titanium dioxide particles sufficiently and to mix under a mixing condition, by which the dispersion of barium and titanium becomes homogeneous.

A heat treatment of the mixed powder in the present invention includes at least the next first heat treatment step and second heat treatment step.

In the first heat treatment step, the mixed powder is subjected to a heat treatment, so that a barium titanate phase is generated on surfaces of titanium dioxide particles. Next, titanium dioxide particles having a barium titanate phase on surfaces thereof and the mixed powder yet to be reacted are subjected to a heat treatment at 800 to 1000° C. in the second heat treatment step so as to obtain barium titanate particles. In the first heat treatment step and second heat treatment step, the powder may be subjected to the heat treatment in a state of powder as it is, or the powder may be pulverized or made to be pellets by pressure molding. Note that prior to the first heat treatment, a binder removal step from the pressure molded (at a heat treatment at around 250 to 450° C.) may be performed or a heat treatment step at around 250 to 500° C. may be performed to remove organic components, such as dispersant at the time of the mixed dispersion. The heat treatment step for removing the organic components is different from the first heat treatment step and does not affect the effects of the present invention.

A heat treatment temperature in the first heat treatment step varies in accordance with a heat treatment atmosphere, etc. but it is lower than a heat treatment temperature of the second heat treatment step and may be sufficient if it allows a barium titanate phase to be formed on the surfaces of titanium dioxide particles as a result of a reaction of titanium dioxide particles and a barium compound.

Also a heat treatment time of the first heat treatment step may be sufficient time to allow that 15 wt % or more, preferably 20 to 75 wt % and more preferably 25 to 55 wt % of the mixed powder become barium titanate and the resulting barium titanate phase has an average thickness of 3 nm or more, preferably 4 to 10 nm, and more preferably 4 to 7 nm on the surfaces of titanium dioxide particles. The barium titanate phase on the surfaces of titanium dioxide particles is a continuous thin layer and it is preferable that even a thin part thereof has a thickness of at least 2 to 3 nm. It is also preferable that at least ¾ of the titanium dioxide particles have a barium titanate phase as such on surfaces thereof.

When a generating rate of barium titanate in the first heat treatment step is less than 15 wt % or an average thickness of the barium titanate phase is thinner than 3 nm, a ratio of a barium titanate phase on surfaces of titanium dioxide particles becomes insufficient and the shielding effect given by the barium titanate phase on the surfaces of titanium dioxide particles declines. As a result, when a titanium dioxide particle contacts with other titanium dioxide particles, they may be sintered to cause irregular particle growth, which leads to a deterioration of a particle size distribution of the resulting barium titanate particles as a dielectric powder and a deterioration of crystallinity.

In the case where a heat treatment step for, for example, increasing a generating rate of barium titanate of 70 wt % or more without uniformly generating a barium titanate phase on the surfaces, or in the case where an average thickness of the barium titanate phase is too thick, particle growth and necking are also easily caused among the titanium dioxide particles during the generation. Furthermore, it also causes a state where Ba ions are unhomogeneously dispersed in titanium dioxide, so that high crystallinity is hard to be obtained and homogeneity of Ba/Ti composition in powder declines.

A step of sufficiently promoting the reaction by inserting an intermediate heat treatment step at 700 to 800° C. may be added between the first heat treatment step and the second heat treatment step. Since the effect of the present invention is to form a continuous layer of barium titanate on the surfaces of titanium dioxide particles in the first heat treatment step, for example, it is possible to perform the first heat treatment step at 600° C., the intermediate heat treatment step at 750° C. and the second heat treatment step at 950° C.

In the first heat treatment step, a continuous barium titanate phase having an average thickness of at least 4 nm is generated on surfaces of preferably 75% or more, more preferably 80% or more, and particularly preferably 90% of the total number of titanium dioxide particles.

A generating amount of barium titanate and an average thickness of the barium titanate phase may be controlled by changing a temperature and time of the heat treatment. The temperature and time of the treatment can be suitably set in accordance with an amount of the mixed powder and a capacity of a furnace, etc. For example, by setting the heat treatment temperature higher or setting the heat treatment time longer, a generating amount of barium titanate and an average thickness of the barium titanate phase tend to increase. However, when the heat treatment temperature is too high, particle growth of barium compound particles and titanium dioxide particles as materials starts prior to reaction therebetween, which results in limiting the barium titanate particles to be made finer.

Therefore, when performing the first heat treatment step by using a normal firing furnace under a pressure between 1×10³ Pa and 1.0133×10⁵ Pa, the temperature is preferably 575 to 650° C., more preferably 580 to 640° C., and particularly preferably 590 to 630° C. Here, a normal firing furnace indicates a furnace for firing the mixed powder in a still state, such as a batch furnace. Raising temperature may start from the room temperature or the mixed powder may be preheated before the temperature raising operation. In that case, the heat treatment time may be sufficient time for generating a predetermined thickness of a barium titanate phase on the surfaces of titanium dioxide and generating a predetermined amount of barium titanate; generally, the holding time is 0.5 to 6 hours and preferably 1 to 4 hours at the heat treatment temperature as above. When the heat treatment temperature is too low or the heat treatment time is too short, there is a possibility that a predetermined barium titanate phase is not generated.

In the temperature raising process up to the heat treatment temperature as above, the temperature raising speed is preferably 1.5 to 20° C./minute or so. An atmosphere in the temperature raising process is not particularly limited and may be in the air, nitrogen gas or other gas atmosphere, or reduced pressure or vacuum atmosphere.

Alternately, the first heat treatment step may be performed in a firing furnace for firing a powder substance while fluidizing it. In that case, the heat treatment is performed in the air at preferably 600 to 700° C., more preferably 620 to 680° C., and particularly preferably 625 to 650° C. Here, as the firing furnace for firing a powder substance while fluidizing it, for example, a rotary kiln may be mentioned. A rotary kiln is an inclined heating tube and has a mechanism of rotating about a center axis of the heating tube. The mixed powder taken in from the upper portion of the heating tube is heated in the process of moving inside the tube downward. Accordingly, by controlling a temperature of the heating tube and the passing speed of the mixed powder, an intended temperature of the mixed powder and the temperature raising speed can be suitably controlled. A holding time at the heat treatment temperature is 0.1 to 4 hours, preferably, 0.2 to 2 hours.

Also, in the first heat treatment step, CO₂ gas concentration in an atmosphere is controlled to preferably 15 mole % or lower, more preferably 0 to 10 mole %, and particularly preferably 0 to 5 mole %.

Concentration of the CO² gas may be controlled to be 15 mole % or lower by calculating from a maximum generating amount per hour generated from the reaction of the mixed powder and a gas flow amount for replacing the atmosphere in the furnace in the heat treatment and by adjusting the flow amount of gas to be replaced. When the CO² gas concentration becomes high in the first heat treatment step at 600 to 650° C., barium titanate to be generated becomes 10 wt % or less of the mixed powder, therefore, it is also possible to indirectly estimate the CO² gas concentration in the atmosphere from the generating amount of barium titanate. In the first heat treatment step, preferably, the CO² gas concentration in the atmosphere is kept under a certain level, while the second heat treatment step is not affected by the CO² gas concentration.

The second heat treatment step may be performed immediately after the first heat treatment step. Alternately, a temperature lowering process may be inserted between the first heat treatment step and the second heat treatment step. Specifically, after the first heat treatment step, the obtained product may be cooled to 550° C. or lower, for example, to the room temperature before performing the second heat treatment step. By lowering to the temperature of suspending formation of a barium titanate phase on the surfaces, it is possible to divide the reaction only to the surfaces of titanium dioxide. Due to this, in dispersion of Ba ions into titanium dioxide, it is possible to reduce variation in the composition caused by allowing a reaction in the first heat treatment step and a reaction in the second heat treatment step performed successively, which is favorable. Furthermore, since it is difficult to form a barium titanate phase on the surfaces of all titanium dioxide particles completely continuous, it is preferable in terms of improving the particle size distribution by suspending necking or other reaction at contacting portions by lowering the temperature temporarily to 550° C. or lower. Alternately, it becomes also possible to separate the firing furnace for performing the first heat treatment step and that for performing the second heat treatment step, which is preferable for it gives flexibility in designing the process.

The first heat treatment step may be performed under a reduced pressure of lower than the atmospheric pressure, for example, about 1×10³ Pa or lower at 450 to 600° C., preferably 475 to 550° C. and more preferably 500 to 540° C. A holding time at the heat treatment temperature is 0.5 to 6 hours, preferably, 1 to 4 hours.

Under a reduced pressure lower than the atmospheric pressure, for example, as low as 10 Pa, a temperature at which a barium titanate phase is generated on the surfaces of titanium dioxide becomes lower than that under the atmospheric pressure by 50 to 80° C. Consequently, it is easy to prevent particle growth of the titanium dioxide particles. However, when performing the first heat treatment in a reduced pressure, it is necessary to take out carbon dioxide gas generated in the reaction process, so that a large facility becomes necessary. Also, there is a possibility that a carbon dioxide gas is removed from barium carbonate to generate barium oxide (BaO) and causes unevenness in the reaction and there arises a concern about an influence of defective titanate oxide (TiOₓ) due to shortage of oxygen on the surfaces of titanium dioxide, so that the reaction control is not easy.

By performing the first heat treatment step as explained above, 15 wt % or more of the mixed powder becomes barium titanate and a barium titanate phase having an average thickness of at least 3 nm is generated on the surfaces of titanium dioxide particles.

It is possible to confirm whether a predetermined barium titanate phase is generated or not in the first heat treatment step by a powder X-ray diffraction analysis and transmission electron microscope analysis of a product of the first heat treatment step. Accordingly, when carrying out the production method of the present invention, it is preferable to further comprise a step of examining a product generated in the first heat treatment step by a powder X-ray diffraction analysis and transmission electron microscope analysis after the first heat treatment step before moving to the second heat treatment step.

Next, the second heat treatment step is performed. A heat treatment temperature in the second heat treatment step is 800 to 1000° C., preferably 850 to 950° C., and more preferably 900 to 950° C. In the present invention, as explained above, the second heat treatment is performed after forming a barium titanate phase on the surfaces of titanium dioxide in the first heat treatment step, consequently, fine powder of barium titanate having preferable tetragonality, high crystallinity and uniform particle morphology can be obtained. The heat treatment time may be sufficient time for substantially completing the solid-phase reaction between barium carbonate particles and titanium dioxide particles, and the holding time at the heat treatment temperature is generally 0.5 to 4 hours, preferably 0.5 to 2 hours. An atmosphere in the heat treatment is not particularly limited and may be in the air, nitrogen gas or other gas atmosphere, or reduced pressure or vacuum atmosphere. When the heat treatment temperature is too low or when the heat treatment time is too short, there is a possibility that uniform barium titanate particles cannot be obtained.

In the process of raising the temperature to the heat treatment temperature, the heat raising rate is preferably 1.5 to 20° C./minute or so. An atmosphere in the temperature raising process is not particularly limited and may be in the air, nitrogen gas or other gas atmosphere, or reduced pressure or vacuum atmosphere.

The second heat treatment step may be performed by using a general electric furnace, such as a batch furnace. Alternately, when performing a heat treatment successively on a large amount of mixed powder, a rotary kiln may be used.

Through the second heat treatment step, barium ion is dispersed via the barium titanate phase formed on the surfaces of titanium dioxide in the first heat treatment step, and barium titanate particles having a small particle size is obtained in the initial stage of the heat treatment. The fine barium titanate particles grow by continuing the heat treatment. Accordingly, according to the present invention, by suitably setting the heat treatment time, barium titanate particles having a desired particle size can be obtained easily. Particularly, according to the present invention, since barium titanate particles having uniform particle morphology can be obtained, irregular particle growth is suppressed when performing particle growth. After the heat treatment, the temperature is lowered and barium titanate particles are obtained. The temperature lowering rate here is not particularly limited and may be 3 to 100° C./minute or so in terms of safety, etc.

According to the present invention, particle growth is suppressed when producing barium titanate, and fine barium titanate particles having preferable tetragonality, high crystallinity and uniform particle morphology can be obtained particularly at the initial stage of the heat treatment.

A ratio c/a of c-axis and a-axis, which is an index of tetragonality, is obtained by an X-ray diffraction analysis and is preferably 1.008 or larger, more preferably, 1.009 or larger.

Crystallinity of barium titanate particles can be evaluated, for example, by a half bandwidth of a peak of the (111) plane in an X-ray diffraction chart. The narrower the half bandwidth is, the higher the crystallinity is.

Crystallinity of barium titanate particles can be also evaluated by a ratio (I₍₂₀₀₎/I_{b}) (hereinafter, referred to as “K value”) of peak intensity (I₍₂₀₀₎) of a diffraction line assigned to the (200) plane to intensity (I_{b}) at a midpoint of an angle of a peak point of a diffraction line assigned to the (002) plane and an angle at a peak point of a diffraction line assigned to the (200) plane in the X-ray diffraction chart. The larger the ratio (I₍₂₀₀₎/I_{b}) is, the higher the crystallinity is. The K value is preferably 4 or larger as a dielectric powder material.

Particle morphology can be evaluated by measuring the particle sizes by an X-ray diffraction analysis or scanning type electron microscope and calculating variability of the particle sizes variability of particle sizes can be examined, for example, from an average particle size and standard deviation of particle sizes. Alternately, variability of particle size can be examined from a particle size distribution ((D80−D20)/D50) or ((D90−D10)/D50). Also, particle morphology can be examined from a specific surface area by using the BET method.

Barium titanate particles obtained by the present invention is pulverized in accordance with need, then, used as a material for producing dielectric ceramics and an inhibitor to be added to paste for forming electrode layers. To produce dielectric ceramics, a variety of well-known methods can be applied without any restrictions. For example, subcomponents to be used in producing dielectric ceramics may be suitably selected in accordance with desired dielectric characteristics. Also, well-known methods may be suitably used in fabricating paste and green sheets, forming electrode layers and sintering green bodies.

As above, the present invention was explained by taking an example of producing barium titanate as dielectric particles, however, the production method of the present invention can be applied as production methods of a variety of dielectric particles having a step of performing a heat treatment on mixed powder including titanium dioxide particles and barium compound particles. For example, to synthesize (Ba, Sr)TiO₃, (Ba, Ca)TiO₃, (Ba, Sr)(Ti, Zr)O₃, (Ba, Ca)(Ti, Zr)O₃, etc., compounds to be a Sr source, Ca source and Zr source may be added during the above solid-phase reaction, or compounds to be a Sr source, Ca source and Zr source may be added after synthesizing barium titanate, to further perform a heat treatment (firing).

Below, the present invention will be explained based on further detailed examples, however, the present invention is not limited to these examples.

As a titanium dioxide material, two kinds were prepared: titanium dioxide particles having a preferable particle size distribution obtained by a gas-phase method using a titanium tetrachloride as a material. The titanium dioxide material is not particularly limited, but the remarkable effect of the present invention cannot be obtained if not using a material having a specific surface area of 20 m²/g or larger and a preferable particle size distribution. As starting materials, the two kinds of titanium dioxide particles shown in Table 1 were used. The reason of choosing two kinds of materials is to prove that the effect of the present invention does not depend on the material.

TABLE 1

| | Specific | | Other | | |
|---|---|---|---|---|---|
| | Surface | | Impurity | Rutile | Particle Size |
| | Area | Impurity | Concen- | Ratio | Distribution |
| | [m2/g] | Chlorides | tration | [%] | (D90 − D10)/D50 |
| TiO2 (A) | 31.2 | <600 ppm | <100 ppm | 13.9 | 1.36 |
| TiO2 (B) | 33.3 | <600 ppm | <100 ppm | 9.1 | 1.04 |

Properties of the above titanium dioxide particles were evaluated as explained below.

### <Specific Surface Area>

A specific surface area of titanium dioxide particles as a material was measured by the BET method. Specifically, measurement was made by using NOVA 2200 (high speed surface area analyzer) under a condition of a powder quantity of 1 g, a nitrogen gas, one-point method, holding time of 15 minutes at 300° C. under deaerating condition.

### <Residual Chloride Content>

Titanium dioxide particles in an amount of 10 mg used as a material was distilled with steam at 1100° C., decomposed product was collected in 0.09% hydrogen peroxide in an amount of 5 ml, and a chloride quantity was determined by ion chromatography.

### <Other Impurity Concentration>

A plasma spectrometry was used to evaluate a quantity of impurities other than chloride.

### <Rutile Ratio>

A rutile ratio was measured by an X-ray diffraction analysis of titanium dioxide particles used as the material. Specifically, a full-automatic multipurpose X-ray diffractometer “D8 ADVANCE” made by Bruker AXS was used; a measurement was made under a condition of Cu-Kα, 40 kV, 40 mA, 2θ: 20 to 120 deg; and a 1D-Super-speed Detector Lynx Eye, a divergence slit of 0.5 deg, scattering slit of 0.5 deg were used. Also, scanning was performed with 0.01 to 0.02 deg at a scanning speed of 0.3 to 0.8 s/div. For analyzing, Rietveld analysis software (TOPAS made by Bruler AXS) was used.

### <Particle Size Distribution>

Particle size of titanium dioxide as a material was evaluated by using a laser diffraction scattering method. As a laser diffraction particle size distribution meter, MT3000 (Microtrac particle size analyzer made by NIKKISO Co., Ltd.) was used, and dispersion obtained by adding a dispersant in an amount of 0.4 wt % to a pure water solution and ultrasonically dispersed was used to calculate particle sizes of accumulation 10%, accumulation 50% and accumulation 90% from the finer powder side of the accumulation particle size distribution.

Also, as a barium compound as a starting material, barium carbonate particles having a BET specific surface area of 30 m²/g was used. The specific surface area was measured in the same way as explained above. Barium carbonate particles are not necessarily limited to those having a large specific surface area, however, a material having 30 m²/g was chosen to improve uniformity of mixed dispersion.

### Examples 1 to 3

### Fabrication of Mixed Powder

Barium carbonate particles having a specific surface area of 30 m²/g and titanium dioxide particles (TiO₂(A)) were weighed so that a Ba/Ti ratio becomes 0.997, wet mixed for 72 hours by a ball mill having a capacity of 50 litters, wherein zirconia (ZrO₂) having a 2 mm diameter was used as a medium, then, dried by spray drying so as to obtain mixed powder. The wet mixing was performed under a condition that slurry concentration was 40 wt % and a polycarboxylate-based dispersant was added in an amount of 0.5 wt %. Here, titanium dioxide particles are fine particles having a relatively large specific surface area, so that the materials have to be mixed sufficiently.

### First Heat Treatment Step

A temperature of the mixed powder was raised from the room temperature to the first heat treatment temperature shown in Table 2 (T₀=600° C.) under the atmospheric pressure in the air at a temperature raising rate of 3.3° C./minute (200° C./hour). After that, the heat treatment temperature was held for two hours and the temperature was lowered by 3.3° C./minute (200° C./hour). An example obtained by using TiO₂(A) as a titanium dioxide material, setting the first heat treatment temperature (T₀) to 600° C. and holding time to 2 hours was referred to as Example 1A. An example wherein TiO₂(B) was used instead was referred to as Example 1B. When the first heat treatment step was performed in a batch furnace, the mixed powder in an amount of 100 to 250 g was filled in an alumina container and a heat treatment was performed under a condition of applying an air flow so that CO₂ gas concentration generated during the reaction becomes 15 mole % or lower.

Powder X-ray diffraction analysis and transmission electron microscope analysis were conducted on a product of the first heat treatment step, and a generation amount of barium titanate and an average thickness of a barium titanate phase on surfaces of titanium dioxide were measured. The measurement was made under the conditions below.

### Powder X-ray Diffraction Analysis

Measurement was made under the same condition as that in the case of titanium dioxide particles explained above. The results were analyzed by using Rietveld analysis software (TOPAS made by Bruker AXS) and weight concentration of barium titanate was calculated.

### Transmission Electron Microscope Analysis—TEM Analysis

By using a transmission electron microscope (HD-2000 made by Hitachi High-Tech Manufacturing & Service Corporation), a TEM image was obtained by magnification of 200,000 to 600,000 times with an accelerating voltage of 200.0 kV, then, mapping of the composition was performed by using an EDS (energy dispersion type X-ray spectrometer), the background was removed, a peak of titanium dioxide and a peak of barium titanate were divided, and the barium titanate phase on the surfaces of titanium dioxide particles was identified. An average thickness of a barium titanate phase on the surfaces of titanium dioxide was calculated from the STEM image and a 600000-time magnified image of a Z-contrast image. To calculate a ratio of titanium dioxide particles having a barium titanate phase having an average thickness of at least 4 nm formed on surfaces thereof to the total titanium dioxide particles, at least 50 titanium dioxide particles (whose sectional shape can be observed) in views of 6 images by magnification of 200000 times were used for the calculation. Here, a titanium dioxide particle with a barium titanate phase having an average thickness of at least 4 nm formed on a surface thereof indicates a particle covered continuously in the particle sectional image. Being covered continuously is defined as a state where a barium titanate phase of 3 nm or more is formed continuously on at least 90% of an outer circumferential portion of the cross section.

Results of Example 1B, wherein TiO₂(B) was used as titanium dioxide particles, are shown in Table 2.

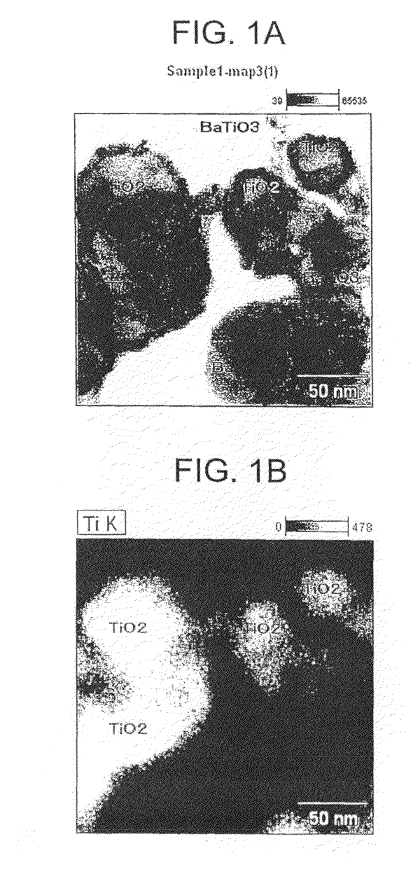

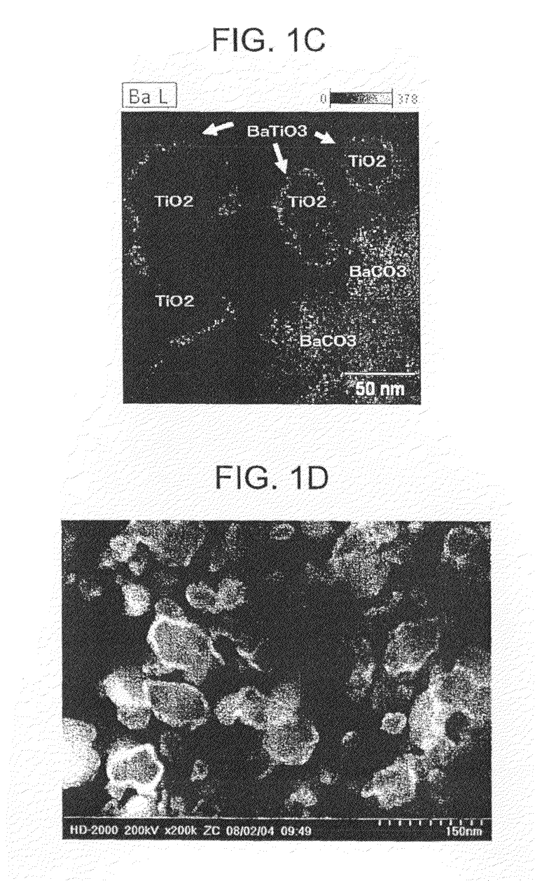

Also, results of TEM observation in the method explained above are shown in FIG. 1A to FIG. 1D. FIG. 1A is a TEM image of observing a barium titanate phase on surfaces by magnification of 600000 times. FIG. 1D is a Z-contrast image, wherein bright partial contrast is observed due to an existence of Ba ions as a heavy element in the surface barium titanate phase. From the results, it is confirmed that the surface barium titanate phase is continuous and has a thin layer structure. FIG. 1B and FIG. 1C are mapping images by an EDS (energy dispersion type X-ray spectrometer) of the Ti—K ray and Ba-L ray. Although a thickness and continuity of the layer cannot be clearly observed in mapping due to the resolution performance, Ba ions are selectively observed on peripheries of titanium dioxide particles. A BaTiO₃-covered particle ratio indicates a ratio of the number of particles in a state, where at least 90% of each outer circumferential portion of the cross section is continuously covered with a barium titanate phase of 3 nm or thicker, to the total number of titanium dioxide particles. A BaTiO₃ generating rate is wt % of the generated BaTiO₃ phase in the mixed powder, obtained by calculation based on the powder X-ray diffraction analysis.

TABLE 2

| | First Heat | | BaTiO3 | |
|---|---|---|---|---|
| | Treatment Step | | Generating | BaTiO3-Covered |
| | T0 | Time | Rate | Particle Ratio |
| | [° C.] | [h] | [Weight %] | [%] |
| Comparative | 450 | 2 | 0 | 0 |
| Example 2B | | | | |
| Comparative | 550 | 2 | 6 | 11 |
| Example 3B | | | | |
| Example 1B | 600 | 2 | 33 | 89 |
| Example 2B | 650 | 2 | 50 | 88 |

Except for changing the heat treatment temperature in the first heat treatment step to 650° C., Example 2B was conducted in the same operation as that in Example 1B. In the same way, Example 3B was produced by only changing the heat treatment temperature in the first heat treatment step to 700° C. The TEM analysis results are also shown in Table 2.

### Comparative Examples 1 to 3

Except for not performing the first heat treatment step, Comparative Example 1 was conducted in the same operation as that in Example 1. Comparative Example 1A was conducted by using titanium dioxide TiO₂(A) as a material; and Comparative Example 1B was conducted by using TiO₂(B) instead. In Comparative Example 1, although the first heat treatment step was not performed, the highest temperature of the spray dryer drying condition was 250° C. after the wet pulverization; therefore, it was listed as being subjected to a heat treatment at a temperature of 250° C. in the tables and figures.

Except for not performing the first heat treatment step, performing a heat treatment for removing organic components from the mixed powder at 450° C. for two hours, Comparative Example 2 was conducted in the same operation as that in Comparative Example 1. Comparative Example 2 was also listed as being subjected to a heat treatment at 450° C. for comparison in tables and figures.

Except for changing the heat treatment temperature in the first heat treatment step to 550° C., Comparative Example 3 was conducted in the same operation as that in Example 1. The TEM analysis results are also shown in Table 2.

As in the results of Table 2, in the case of performing the first heat treatment step at 550° C., barium titanate was generated in an amount of 6 wt % but the BaTiO₃-covered particle ratio was 10% or so. In Example 1B and Example 2B, the covered ratios were confirmed to be 85% or higher. In Example 1B, when observing a relatively uniformly covered titanium dioxide particle as a typical particle, an average thickness of the barium titanate continuous layer was 4 to 5 nm or so. It was 3 to 3.5 nm at thin portions and 5 to 7 nm at thick portions. In Example 2B, the covered ratio was equivalent, however, the thickness was 7 to 10 nm in a uniformly covered typical particle but the thickness varied much. Moreover, some of smaller titanium dioxide particles in the distribution were observed that their inside also became barium titanate.

### Examples 4 to 6

Mixed powder was fabricated in the same way as in Example 1B.

### <First Heat Treatment Step>

A heat treatment was performed on the mixed powder by using a rotary kiln furnace (referred to as “RK furnace”) in the air with the first heat treatment temperature of 600° C. for 0.3 hour. The treatment time of 0.3 hour was an average retention time for the powder to be in the temperature holding part of the rotary kiln furnace. Example 4B was conducted, wherein titanium dioxide as a material was TiO₂(B) and the first heat treatment step was performed at 600° C. for 0.3 hour in the RK furnace. Except for changing the temperature of the first heat treatment step to 650° C., Example 5B was conducted in the same operation as that in Example 4B. Except for changing the temperature of the first heat treatment step to 700° C., Example 6B was conducted in the same operation as that in Example 4B.

Comparing to a batch furnace (referred to as “B furnace”) for performing a heat treatment by keeping the mixed powder in a still state, a rotary kiln furnace (RK furnace), wherein the mixed powder is kept fluidized, was used as an example of firing furnaces giving fluidity to the subject.

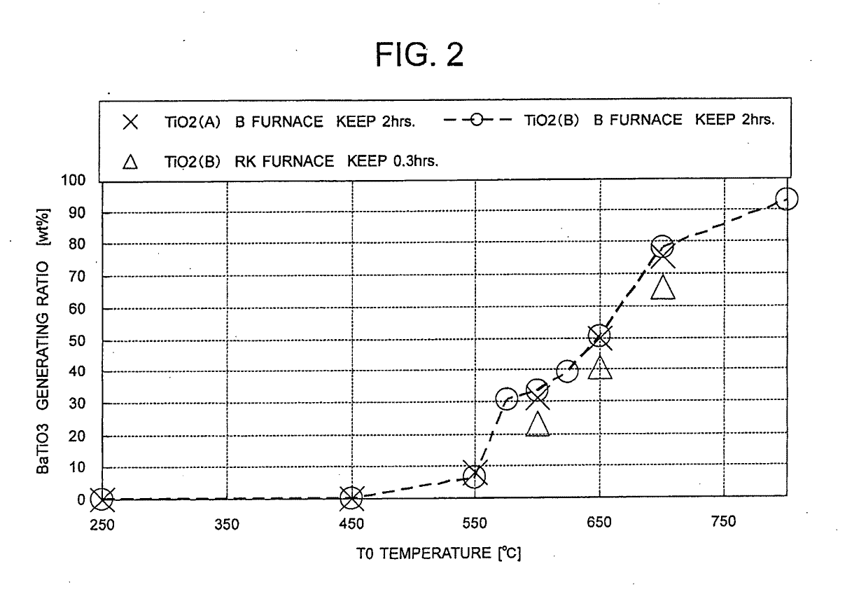

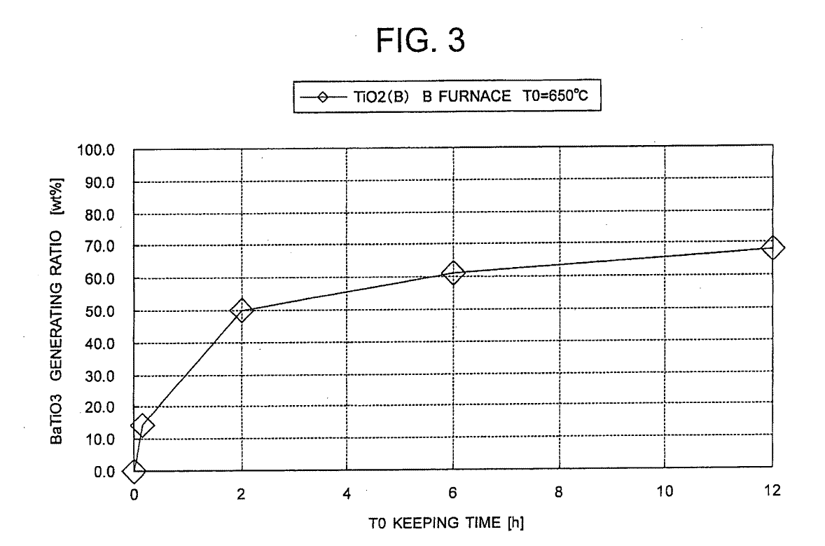

Results of generating rates of barium titanate in Examples 1 to 3 and Comparative Examples 1 to 3 calculated from powder X-ray diffraction analysis are shown in FIG. 2 and FIG. 3.

FIG. 2 also shows those subjected to the first heat treatment step at temperatures of 575° C., 625° C. and 800° C., and FIG. 3 also shows those with the holding time of 0 to 12 hours when T₀ was 650° C.

From the results in FIG. 2, no significant difference was observed between the materials TiO₂(A) and TiO₂(B). Between the temperatures 575° C. and 625° C., almost stable reactions of 30 to 40 wt % were exhibited. In this first heat treatment temperature range, as shown in the TEM results, a state where a thin barium titanate phase of at least 3 nm is continuously covered on the surfaces of titanium dioxide was observed. When the heat treatment temperature in the first heat treatment step was 700° C. to 800° C., the barium titanate reaction was promoted and 75 wt % or more became the barium titanate phase. However, since the specific surface area of titanium dioxide was 30 m²/g or larger, it is considered that a reaction that the specific surface area of TiO₂ abruptly declined was brought, that is, particle growth of titanium dioxide was simultaneously promoted at this temperature. Also, even by using as a material those having a rutile ratio of 30% or lower, changing from the anatase structure to the rutile structure is caused at 700° C. or higher, and the rutile ratio of the material cannot be sufficiently reflected. Therefore, the first heat treatment temperature is preferably at 575° C. to 650° C. under the atmospheric pressure in the air. Note that, in this temperature range, the reaction does not become stable unless the CO₂ gas concentration in the furnace atmosphere is kept at 15 mole % or lower. For example, if the first heat treatment is performed at 625° C. in an atmosphere with 50 mole % of CO₂ intentionally, the resulting barium titanate becomes 5 wt % or less. When the mixed powder amount is, for example, 1 kg or more, CO₂ generated due to the reaction cannot be ignored. When the mixed powder amount is large, in addition to replacing the atmosphere, the influence of the CO₂ gas may be reduced by imposing a pressure between 1×10³ Pa and 1.0133×10⁵ Pa by exhausting by suction, etc.

From the results in FIG. 2, since the reaction time was short as 0.3 hour in the RK furnace for performing firing while fluidizing the powder, there was a tendency that the generating rate of barium titanate was lower than that in the case of holding for two hours in the batch furnace (B furnace), wherein the powder remained still. However, comparing to the B furnace, the temperature raising and lowering processes are rapid in the RK furnace, which is equivalent to a temperature raising rate of 50° C./minute or more. Therefore, it is hard to be affected by ununiformity in particle growth, etc. of the material in the temperature raising process and, furthermore, because the powder is fluidized, a temperature unevenness due to heat conduction, etc. inside the powder and an influence of CO₂ gas partially generated from the reaction are expected to be largely reduced.

From the results in FIG. 3, in the case where the holding time was 10 minutes (the temperature raising and lowering rates were 3.3° C./minute as same as those in other cases), generation of barium titanate was 14 wt % which is not sufficient as the first heat treatment step. The generating rate here also includes the reaction in the temperature raising and lowering processes. Also, there is a tendency that the reaction saturates after two hours of holding time, and the reaction proceeds slowly in 6-hour and 12-hour holding time. When the holding time is short, the effect of the first heat treatment step of the present invention was not observed. It is preferable that the holding time is suitably set in accordance with an amount of the mixed powder and a temperature distribution in the furnace.

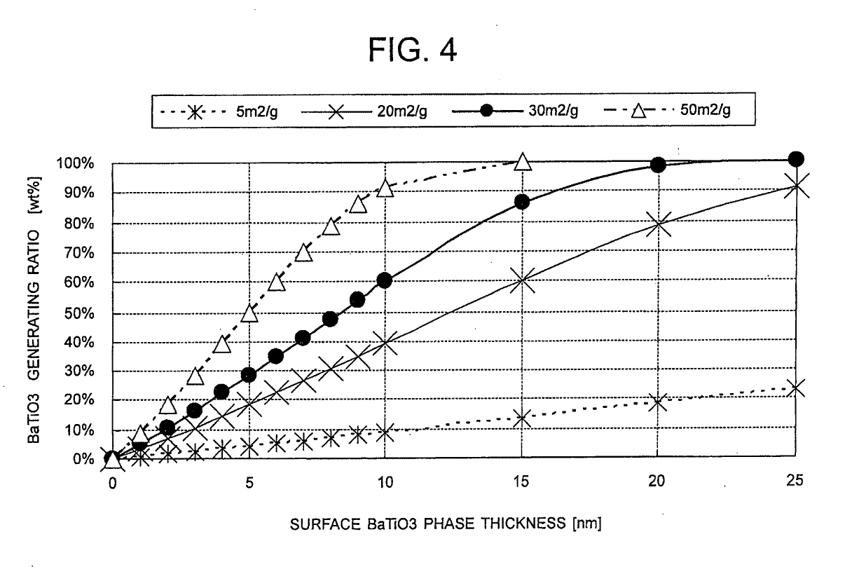

FIG. 4 shows the results of valuating a thickness of the barium titanate phase on the surfaces and a generating rate of barium titanate in the cases where a specific surface area of the material was 5, 20, 30 and 50 m²/g.

Valuating was made by calculation on an assumption that a barium titanate phase was formed ideally on the surfaces based on the assumptions below.

On assumptions that the reaction of barium titanate on the surfaces was ideally uniform and ideal titanium dioxide particles are completely sphere particles having a uniform particle size, a generating rate of barium titanate with respect to the thickness of the surface reaction layer was calculated in wt %.

Note that particle growth, etc. of titanium dioxide particles due to the heat treatment is not taken into consideration here, therefore, it does not reflect an actual barium titanate generating rate as it is from the treatment at the first heat treatment temperature.

In FIG. 4, a layer thickness was estimated to be 3 nm when the barium titanate generating rate becomes 15 wt % or higher in the case where titanium dioxide particles having a specific surface area of 30 m²/g was used as the material. It is difficult to completely realize the ideal state in actual powder, however, in Example 1, the surface barium titanate phase was 4 to 5 nm and the barium titanate generating rate was 30 wt %, which are quite close to the ideal state. This result is considered to logically support the TEM result. Accordingly, it was proved that Example 1B realized the state intended by the present invention.

### <Second Heat Treatment Step>

A second heat treatment step was performed on powder of Examples 1 to 6 and Comparative Examples 1 to 3 after being subjected to the first heat treatment step. After the first heat treatment step, the temperature was once lowered to the room temperature and the powder was respectively subjected to the second heat treatment step in a batch furnace (B furnace) under the condition that the temperature was 900 to 1000° C. and the holding time was 2 to 12 hours. The second heat treatment step was performed under the atmospheric pressure in the air, the temperature raising rate was 3.3° C./minute (200° C./hour), the temperature lowering rate was 3.3° C./minute (200° C./hour), and 5 to 50 g of the powder was filled in an alumina container during the treatment. Table 3 and Table 4 show the typical results.

Those subjected to the same first heat treatment as in Example 1A were numbered as Examples 1A-1 to 1A-4. In the same way, Examples 1B-1 to 1B-6, Examples 2B-1 to 2B-3, Examples 3B-1 to 3B-3, Comparative Examples 1A-1 to 1A-3, Comparative Examples 1B-1 to 1B-3, Comparative Example 2B-1, Comparative Examples 3B-1 to 3B-3, Examples 4B-1 to 4B-8, Examples 5B-1 to 5B-5 and Examples 6B-1 to 6B-5 were prepared. In Comparative Examples 1 and 2, To temperature was set as 250° C. and 450° C. as explained above. These were actually not the first heat treatment step, however, these are a heat treatment at a certain temperature, the values were shown in Tables and Figures. In the “powder fluidity” in Table 4, those subjected to the first heat treatment in the batch furnace were categorized as “no” and those subjected to the first heat treatment in the RK furnace were categorized as “yes”.

TABLE 3

| | First Heat | | | Properties of Barium Titanate Particles | | | | |
|---|---|---|---|---|---|---|---|---|
| | Treatment | Second Heat Treatment | | | | Half Bandwidth | Particle Size | Specific |
| | T0 Temperature | T1 Temperature | T1 Holding Time | c/a | K-value | of (111) | (XRD) | Surface Area |
| | [° C.] | [° C.] | [h] | [-] | [-] | [deg.] | [nm] | [m2/g] |
| Example 1A-1 | 600 | 900 | 2 | 1.0090 | 2.1 | 0.151 | 84 | 8.0 |
| Example 1A-2 | 600 | 925 | 2 | 1.0098 | 8.1 | 0.088 | 150 | 4.0 |
| Example 1A-3 | 600 | 950 | 2 | 1.0099 | 10.4 | 0.076 | 176 | 3.5 |
| Example 1A-4 | 600 | 1000 | 2 | 1.0099 | 12.1 | 0.071 | 196 | 2.2 |
| Example 1B-1 | 600 | 900 | 2 | 1.0087 | 1.9 | 0.166 | 72 | 11.1 |
| Example 1B-2 | 600 | 925 | 2 | 1.0098 | 7.5 | 0.094 | 142 | 4.0 |
| Example 1B-3 | 600 | 950 | 2 | 1.0099 | 10.5 | 0.077 | 175 | 3.1 |
| Example 1B-4 | 600 | 1000 | 2 | 1.0100 | 11.5 | 0.073 | 190 | 1.9 |
| Example 2B-1 | 650 | 900 | 2 | 1.0081 | 1.5 | 0.201 | 60 | 12.7 |
| Example 2B-2 | 650 | 925 | 2 | 1.0093 | 2.9 | 0.122 | 99 | 8.2 |
| Example 2B-3 | 650 | 950 | 2 | 1.0100 | 8.0 | 0.076 | 168 | 3.6 |
| Example 3B-1 | 700 | 900 | 2 | 1.0086 | 1.5 | 0.165 | 76 | 10.9 |
| Example 3B-2 | 700 | 925 | 2 | 1.0098 | 6.8 | 0.091 | 144 | 4.3 |
| Example 3B-3 | 700 | 950 | 2 | 1.0099 | 9.0 | 0.077 | 172 | 3.4 |
| Example 1A-5 | 600 | 925 | 6 | 1.0101 | 11.1 | 0.077 | 186 | 2.9 |
| Example 1A-6 | 600 | 925 | 12 | 1.0102 | 13.3 | 0.070 | 205 | 2.5 |
| Comparative | 250 | 925 | 2 | 1.0082 | 1.5 | 0.181 | 64 | 11.0 |
| Example 1A-1 | | | | | | | | |
| Comparative | 250 | 950 | 2 | 1.0097 | 3.6 | 0.101 | 117 | 6.3 |
| Example 1A-2 | | | | | | | | |
| Comparative | 250 | 1000 | 2 | 1.0101 | 6.9 | 0.074 | 153 | 2.6 |
| Example 1A-3 | | | | | | | | |
| Comparative | 250 | 925 | 2 | 1.0087 | 1.5 | 0.157 | 76 | 12.5 |
| Example 1B-1 | | | | | | | | |
| Comparative | 250 | 950 | 2 | 1.0088 | 1.5 | 0.145 | 79 | 9.9 |
| Example 1B-2 | | | | | | | | |
| Comparative | 250 | 1000 | 2 | 1.0099 | 5.3 | 0.079 | 136 | 2.7 |
| Example 1B-3 | | | | | | | | |
| Comparative | 550 | 900 | 2 | 1.0078 | 1.0 | 0.200 | 54 | 13.6 |
| Example 3B-1 | | | | | | | | |
| Comparative | 550 | 925 | 2 | 1.0081 | 1.5 | 0.176 | 67 | 11.5 |
| Example 3B-2 | | | | | | | | |
| Comparative | 550 | 950 | 2 | 1.0088 | 1.8 | 0.144 | 82 | 10.3 |
| Example 3B-3 | | | | | | | | |

TABLE 4

| | First Heat | | Second Heat | | | |
|---|---|---|---|---|---|---|
| | Treatment | | Treatment | | Properties of | |
| | T0 | | T1 | T1 | Barium Titanate | |
| | Tempera- | | Tempera- | Holding | Particles | |
| | ture | Powder | ture | Time | c/a | K-value |
| | [° C.] | fluidity | [° C.] | [h] | [-] | [-] |
| Compara- | 550 | No | 925 | 2 | 1.0081 | 1.5 |
| tive | | | | | | |
| Example | | | | | | |
| 3B-2 | | | | | | |
| Example | 600 | No | 925 | 2 | 1.0098 | 7.5 |
| 1B-2 | | | | | | |
| Example | 600 | No | 925 | 6 | 1.0101 | 11.1 |
| 1B-5 | | | | | | |
| Example | 600 | No | 925 | 12 | 1.0102 | 13.3 |
| 1B-6 | | | | | | |
| Example | 600 | Yes | 900 | 2 | 1.0087 | 2.4 |
| 4B-1 | | | | | | |
| Example | 600 | Yes | 925 | 2 | 1.0098 | 7.5 |
| 4B-2 | | | | | | |
| Example | 600 | Yes | 950 | 2 | 1.0099 | 8.5 |
| 4B-3 | | | | | | |
| Example | 600 | Yes | 1000 | 2 | 1.0100 | 10.0 |
| 4B-4 | | | | | | |
| Example | 600 | Yes | 900 | 6 | 1.0101 | 10.0 |
| 4B-5 | | | | | | |
| Example | 600 | Yes | 925 | 6 | 1.0100 | 11.9 |
| 4B-6 | | | | | | |
| Example | 600 | Yes | 900 | 12 | 1.0101 | 11.5 |
| 4B-7 | | | | | | |
| Example | 600 | Yes | 925 | 12 | 1.0101 | 14.4 |
| 4B-8 | | | | | | |
| Example | 650 | Yes | 925 | 2 | 1.0099 | 8.2 |
| 5B-1 | | | | | | |
| Example | 650 | Yes | 950 | 2 | 1.0100 | 8.1 |
| 5B-2 | | | | | | |
| Example | 650 | Yes | 1000 | 2 | 1.0100 | 9.2 |
| 5B-3 | | | | | | |
| Example | 650 | Yes | 925 | 6 | 1.0101 | 11.7 |
| 5B-4 | | | | | | |
| Example | 650 | Yes | 925 | 12 | 1.0102 | 13.4 |
| 5B-5 | | | | | | |
| Example | 700 | Yes | 925 | 2 | 1.0099 | 7.9 |
| 6B-1 | | | | | | |
| Example | 700 | Yes | 950 | 2 | 1.0100 | 8.4 |
| 6B-2 | | | | | | |
| Example | 700 | Yes | 1000 | 2 | 1.0100 | 9.3 |
| 6B-3 | | | | | | |
| Example | 700 | Yes | 925 | 6 | 1.0101 | 10.9 |
| 6B-4 | | | | | | |
| Example | 700 | Yes | 925 | 12 | 1.0102 | 12.0 |
| 6B-5 | | | | | | |

On the obtained barium titanate particles, an X-ray diffraction analysis was conducted to obtain a c/a value as an index of tetragonality, a ratio (T₍₂₀₀₎/I_{b}) value as an index of crystallinity (hereinafter, referred to as a “K-value”), and a half bandwidth of a peak of a diffraction line assigned to the (111) plane. When calculating the K-value and the half bandwidth of the (111) plane diffraction line, the background was removed and a contribution of a Cu-Kα2 ray was removed to use only a Cu-Kα1 ray.

Note that the K-value is defined by a ratio (I₍₂₀₀₎/I_{b}) of peak intensity (I₍₂₀₀₎) of a diffraction line assigned to the (200) plane with respect to intensity (I_{b}) at a midpoint of a peak point angle of the diffraction line assigned to the (002) plane and a peak point angle of the diffraction line assigned to the (200) plane. However, when the diffraction line is hard to be discriminated, the K-value was described as explained below for convenience.

When the diffraction line assigned to the (200) plane and the diffraction line assigned to the (002) plane were not clear, it was described that the K-value=1.5. When the c/a value was 1.008 or smaller and it was hard to discriminate tetragonal from cubic, it was described that the K-value=1.0.

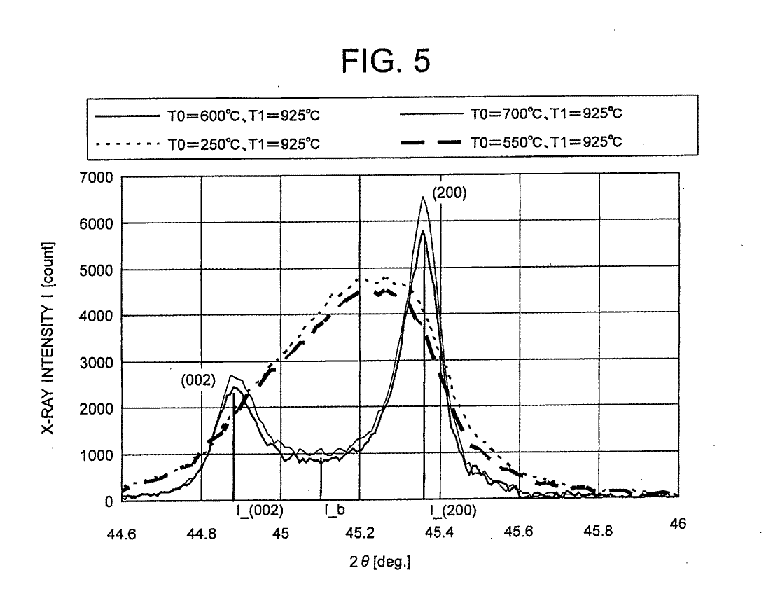

FIG. 5 shows the X-ray diffraction results of barium titanate particles obtained in Example 1B-2, Example 3B-2, Comparative Example 1B-1 and Comparative Example 3B-2, which are basis of calculating the K-value, that is, the ratio (I₍₂₀₀₎/Ib). When comparing in the case where the second heat treatment temperature was 925° C., Examples indicated by solid lines have remarkably improved K-values comparing with those in Comparative Examples indicated by dotted lines. This difference cannot be learnt only by comparing the c/a values.

As disclosed in the Patent Article 1, the K-value is an index which well represents crystallinity when applied to a chip capacitor. Accordingly, in barium titanate, in addition to the c/a ratio as an index of tetragonality, it is necessary that the particle size is small and uniform and the K-value is large.

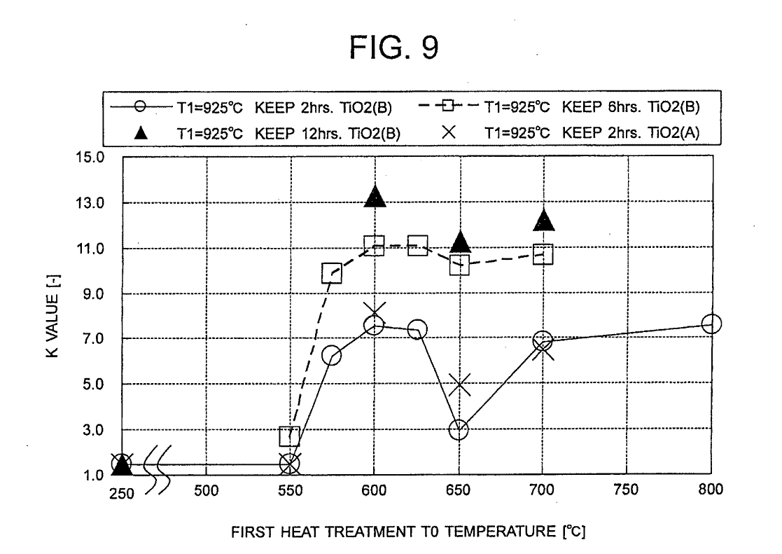

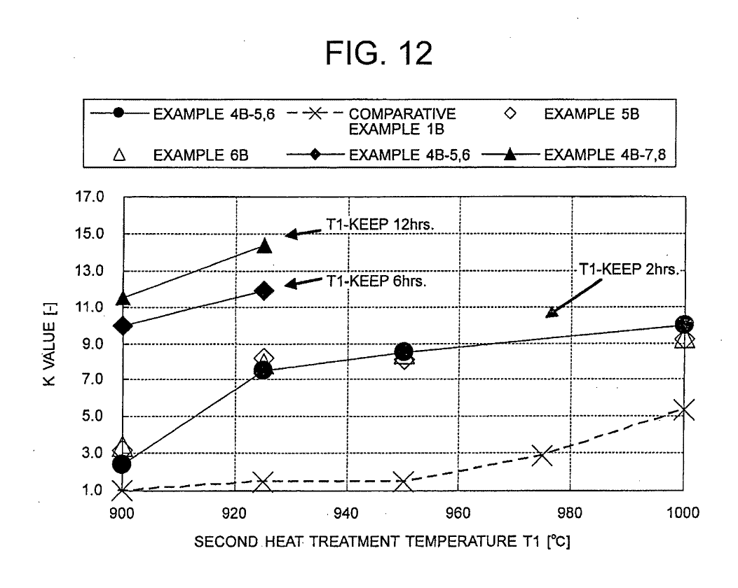

Also, in the present invention, by forming a continuous barium titanate phase on the surfaces in the first heat treatment step, the second heat treatment temperature can be lower, moreover, it is also possible to expect an effect of sufficient particle growth of barium titanate by the long-time second heat treatment and a very large K-value can be realized as shown in FIG. 9 and FIG. 12. The K-value became the largest in Example 4, which is considered to be an effect as a result that the first heat treatment was homogeneous and ideal reaction was achieved. Accordingly, it was found that RK furnace was preferable for performing the first heat treatment step.

Furthermore, the particle size was measured by the Rietveld analysis of an X-ray diffraction line so as to evaluate the particle morphology. The particle size measured by X-ray diffraction is expressed as a particle size (XRD) to discriminate it from a particle size obtained by the SEM and specific surface area. In the same way, the specific surface area was measured.

The X-ray diffraction analysis and the specific surface area measurement were performed in the same way as explained above. The results are shown in Table 3 and Table 4.

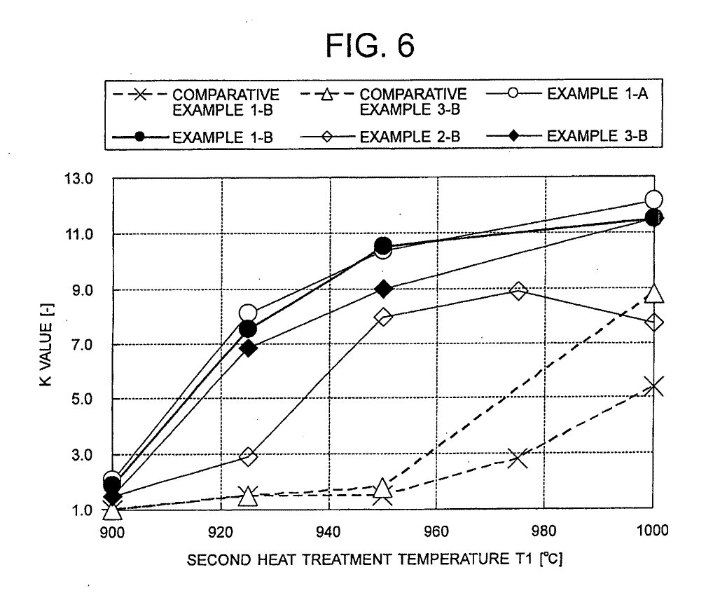

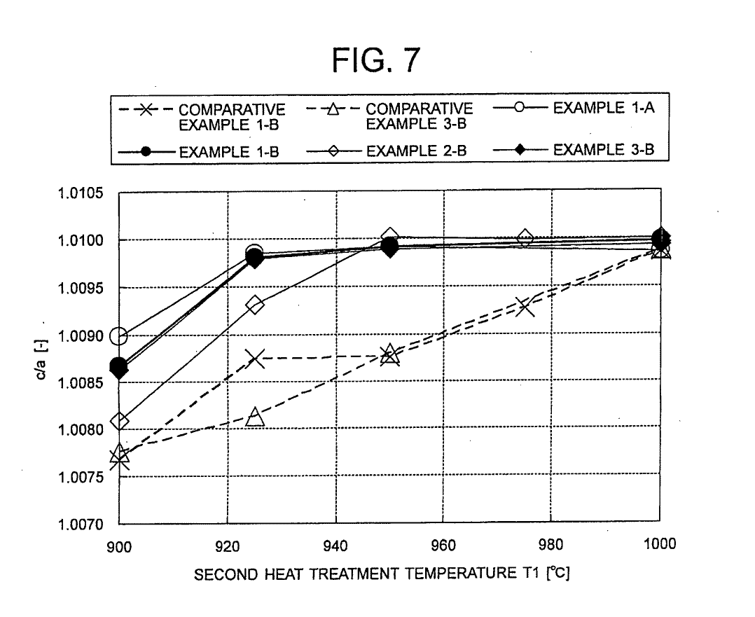

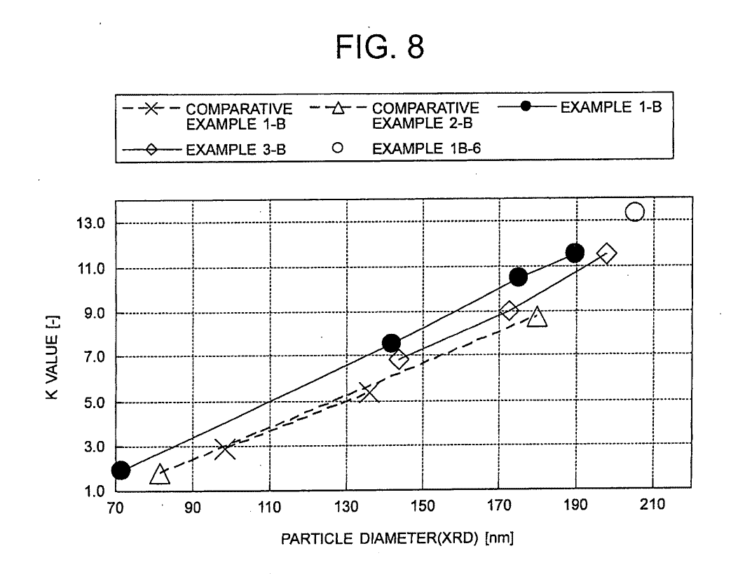

FIG. 6 shows a relationship between the second heat treatment temperature (T₁) and the K-value, FIG. 7 shows a relationship between the second heat treatment temperature (T₁) and the c/a value, and FIG. 8 shows a relationship between the K-value and the particle size. In FIG. 6 and FIG. 7, only those of two-hour holding at the second heat treatment temperature (T₁) are shown for comparison. In FIG. 8, Example 1, Example 3 and Comparative Example 3 with two-hour holding and Example 1B-6 with 12-hour holding are shown.

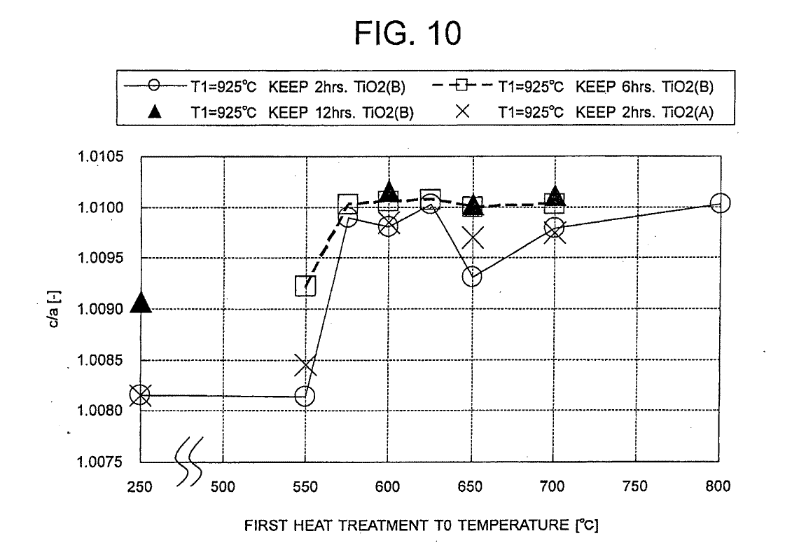

FIG. 9 shows a relationship between the K-value of barium titanate particles at 625° C. of a second heat treatment temperature (T₁) and the first heat treatment temperature (T₀). FIG. 10 shows a relationship between the c/a value of barium titanate particles at 925° C. of a second heat treatment temperature (T₁) and the first heat treatment temperature (T₀).

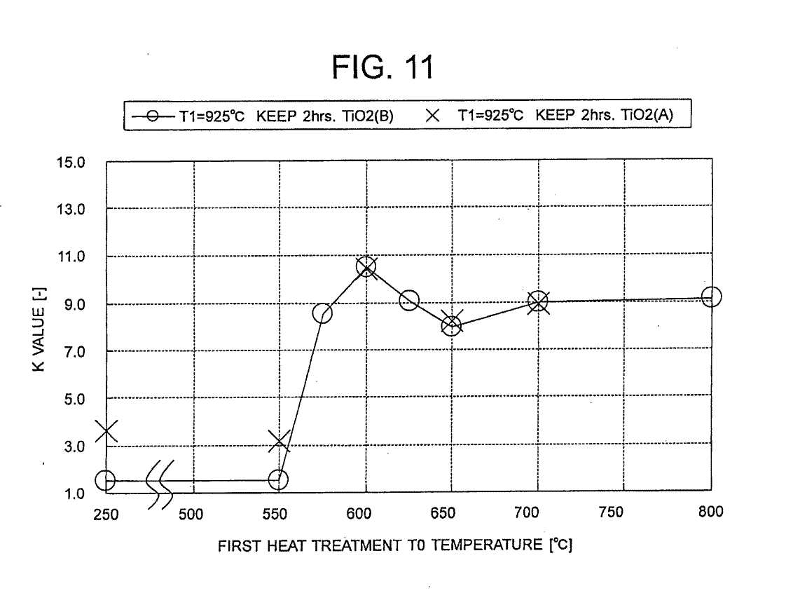

FIG. 11 shows a relationship between the K-value of barium titanate particles at 950° C. of a second heat treatment temperature (T₁) and the first heat treatment temperature (T₀). FIG. 12 shows a relationship between the second heat treatment temperature (T₁) and the K-value in the barium titanate particles obtained in Comparative Example 1B and Examples 4B to 6B.

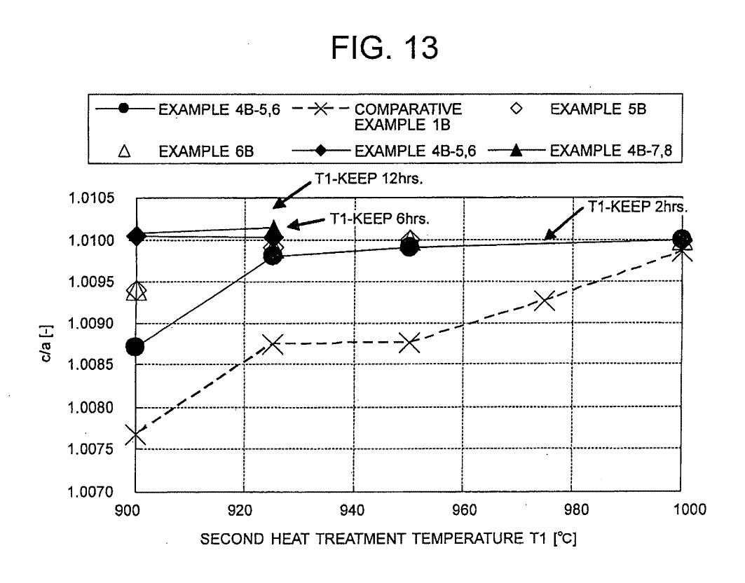

FIG. 13 shows a relationship between the second heat treatment temperature (T₁) and the c/a value in the barium titanate particles obtained in Comparative Example 1B and Examples 4B to 6B.

From the results in Table 3, Table 4, FIG. 7 and FIG. 13, the Examples of the present invention exhibited very high tetragonality as the c/a value of 1.008 or larger or 1.009 or larger. In addition to the c/a value, the Example 1 of the present invention exhibited a high K-value. FIG. 8 showing the results of K-value with respect to the particle size (XRD) tells that the K-value at the same particle size is improved in the Example 1. The results also tells that the crystallinity was improved even when the second heat treatment step was performed at 900 to 950° C., and barium titanate having preferable characteristics can be obtained even at a low second heat treatment temperature.

FIG. 9 to FIG. 11 are graphs wherein the abscissa axis indicates the first heat treatment temperature and the ordinate axis indicates characteristics of barium titanate obtained in the second heat treatment step. In FIG. 9, the K-value and c/a value are most preferable around 600° C. in the first heat treatment. When focusing only on the K-value, the value is also high even at 700° C. and 800° C., however, the K-value with respect to the particle size is deteriorated as shown in FIG. 8 and ununiformity of the particle size also increases, so that it is not preferable in terms of attaining particle uniformity and obtaining finer particles. When making a chip capacitor thinner, fine particles having a large K-value and uniform particle size are required, and the dielectric particles obtained in the present invention satisfy the both qualities.

Scanning electron microscope images of the barium titanate particles obtained in Comparative Example 1B-3, Example 1B-3, Example 3B-3, Example 4B-3 and Example 6B-2 were taken by magnification of 20000 to 50000 times. From the obtained SEM images, 250 or more particles were arbitrarily selected, and an average particle size, standard deviation of the particle sizes, and particle size distributions ((D80−D20)/D50) and ((D90−D10)/D50) were calculated by approximating as a circle by using a commercially available image analysis software. An average particle size was also calculated from a specific surface area based on the BET method.

Calculation of an average particle size from the BET specific surface area was made by the following equation.

BET average particle size=6 (logical density/specific surface area)×1000

The logical density was set to be 5.7 g/cm³.

The results are shown in Table 5.

Comparing to Comparative Example 1B having a specific surface area of around 3 m²/g, the particle size distributions were largely improved in Example 1B and Example 4B. This shows that the particle sizes become uniform in those subjected to the first heat treatment at around 600° C. Since titanium dioxide as the material changes to have a rutile structure at around 700° C. and a specific surface area largely reduces in titanium dioxide alone at 700° C. or higher, the first heat treatment is preferably performed at around 575 to 650° C. under the atmospheric pressure. The Non-patent Article 1 describes a particle size distribution as an M-value, which is an index of 1/(log(D80)−log(D20)). The larger the M-value is, the more preferable the distribution is. When using the M-value as an index as reference, the M-value becomes 5.2 in Comparative Example 1 which is equivalent to the M-value of 5.0 in the non-patent article; while, the M-value was 6.3 in Example 1 and 6.8 in Example 4, showing a large improvement. Accordingly, the dielectric particles obtained in the present invention not only has a large c/a value, large K-value and very preferable crystallinity, but also has considerably uniform particle size.

TABLE 5

| | | | | | | | | | Evaluation by | |
|---|---|---|---|---|---|---|---|---|---|---|
| | First Heat | | | | | | | | BET Method | |
| | Treatment | Second Heat Treatment | | Evaluation by SEM | | | | | Specific | |
| | T0 | T1 | T1 Holding | Average | Particle Size | σ/ | (D80 − | (D90 − | Surface | |
| | Temperature | Temperature | Time | Particle Size | σ | Average | D20)/ | D10)/ | Area | d_bet |
| | [° C.] | [° C.] | [h] | [nm] | [nm] | [%] | D50 | D50 | [m2/g] | [nm] |
| Comparative | 250 | 1000 | 2 | 279 | 98 | 35 | 0.43 | 0.69 | 2.7 | 396 |
| Example 1B-3 | | | | | | | | | | |
| Example 1B-3 | 600 | 950 | 2 | 252 | 53 | 21 | 0.36 | 0.51 | 3.1 | 340 |
| Example 3B-3 | 700 | 950 | 2 | 259 | 81 | 31 | 0.51 | 0.74 | 3.4 | 310 |
| Example 4B-3 | 600 | 950 | 2 | 232 | 49 | 21 | 0.33 | 0.58 | 3.1 | 340 |
| Example 6B-2 | 700 | 950 | 2 | 240 | 61 | 25 | 0.42 | 0.64 | 3.0 | 351 |

### <Dielectric Characteristic Evaluation on Barium Titanate>

For evaluating dielectric characteristics of barium titanate, samples were prepared as explained below. The barium titanate particles obtained in Examples (1B-1, 1A-2, 1B-2, 3B-2, 4B-2 and 6B-1) and Comparative Example (1B-3) of the present invention were added with PVA (a polyvinyl alcohol resin) as a binder in an amount of 10 wt % and molded with pressure so as to obtain disk-shaped samples having a diameter of 12.5 mm and a thickness of about 0.6 mm. Next, as binder removal processing of the obtained disk-shaped samples, a heat treatment was performed at 400° C. with a holding time of 4 hours in the air. After that, another heat treatment was performed at a firing temperature T₂ of 1250° C. The atmosphere was in the air, the holding time was two hours and the temperature raising rate was 3.3° C./minute. On both surfaces of the obtained dielectric characteristic evaluation samples, In—Ga was applied to form electrodes. A diameter of the electrode was made to be 6 mm.

On the obtained samples, a specific permittivity (∈r), ferroelectric transition temperature (T_{C}) and dielectric loss (tan δ) were measured by the methods explained below.

The capacitance C and dielectric loss tan δ of the capacitor samples were measured by imputing a signal having a frequency of 1 khz and an input signal level (measurement voltage) of 1 Vrms by a digital LCR meter at the room temperature of 20° C. and in a temperature tank of −55° C. to 140° C. The specific permittivity ∈r (no unit) was calculated based on a thickness of each of the dielectric samples, effective electrode area and capacitance C obtained from the measurement. The ferroelectric transition temperature (Curie temperature T_{C}) was obtained from a peak temperature of the specific permittivity. The results are shown in Table 6.

TABLE 6

| | First Heat | Second Heat | | Dielectric | | |
|---|---|---|---|---|---|---|
| | Treatment | Treatment | Firing | Characteristics | | |
| | T0 | T1 | T2 | (20° C.) after | | |
| | Tempera- | Tempera- | Tempera- | T2 Firing | | |
| | ture | ture | ture | εr | tanδ | Tc |
| | [° C.] | [° C.] | [° C.] | [-] | [%] | [° C.] |
| Example | 600 | 900 | 1250 | 5980 | 3.6 | 125 |
| 1B-1 | | | | | | |
| Example | 600 | 925 | 1250 | 5877 | 3.7 | 125 |
| 1B-2 | | | | | | |
| Example | 700 | 925 | 1250 | 5182 | 4.5 | 125 |
| 3B-2 | | | | | | |
| Example | 600 | 925 | 1250 | 6226 | 5.1 | 125 |
| 4B-2 | | | | | | |
| Example | 700 | 925 | 1250 | 6256 | 5.2 | 125 |
| 6B-2 | | | | | | |
| Example | 600 | 925 | 1250 | 6453 | 2.9 | 125 |
| 1A-2 | | | | | | |
| Comparative | 250 | 1000 | 1250 | 3990 | 2.1 | 125 |
| Example | | | | | | |
| 1B-3 | | | | | | |

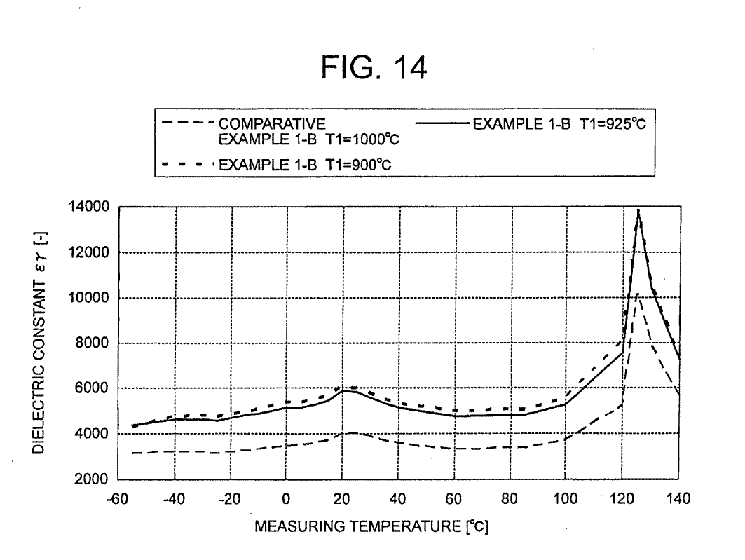

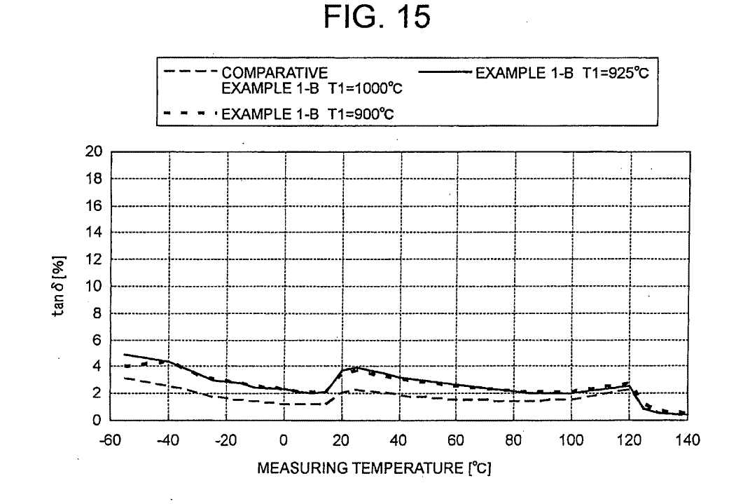

Temperature dependency of the specific permittivity ∈r and dielectric loss tan δ was examined on the dielectric characteristic evaluation samples obtained by using barium titanate particles of Example 1B-1, Example 1B-2 and Comparative Example 1B-3. The results are shown in FIG. 14 and FIG. 15, respectively. A shift of the Curie temperature T_{C} and abnormality of the dielectric loss tan δ were not observed, and the specific permittivity ∈r was drastically improved. This is considered to be also attributed to the improved K-value in addition to the fact that the barium titanate having fine and uniform particles obtained by the present invention has a high c/a.

It was proved that the barium titanate obtained in the present invention had sufficient characteristics as a dielectric material. This means that it exhibits high permittivity because the particles are fine, the K-value is large and the particle size is uniform. Accordingly, according to the present invention, it is possible to obtain fine dielectric particles having high tetragonality while suppressing abnormal particle growth, and a multilayer ceramic capacitor can be made furthermore thinner.

1. A production method of dielectric particles; comprising the steps of:
preparing titanium dioxide particles having a rutile ratio of 30% or lower and a BET specific surface area of 20 m²/g or more;
preparing barium carbonate particles having a BET specific surface area of 10 m²/g or more;
preparing mixed powder by mixing titanium dioxide particles and barium carbonate particles;
performing a first heat treatment step for performing a heat treatment on the mixed powder to generate a barium titanate phase on surfaces of titanium dioxide particles; and
performing a second heat treatment step for performing a heat treatment at 800° C. to 1000° C. after the first heat treatment step, wherein a heat treatment temperature in the first heat treatment step is lower than a heat treatment temperature in the second heat treatment step, and a sufficient time is secured for a reaction to convert at least 15 wt % of mixed powder after the first heat treatment step to barium titanate and generating a barium titanate phase having an average thickness of at least 3 nm on surfaces of titanium dioxide particles.

2. The production method as set forth in claim 1, wherein the first heat treatment step is a step for generating a barium titanate phase having an average thickness of at least 4 nm continuously on surfaces of the titanium dioxide particles in at least 75% of the total titanium dioxide particles, and at least 20 wt % of the mixed powder becomes barium titanate.

3. The production method as set forth in claim 1, wherein a heat treatment temperature in the second heat treatment step is 850° C. to 950° C., and a c/a value of barium titanate particles to be generated is 1.008 or larger.

4. The production method as set forth in claim 1, wherein a heat treatment temperature in the second heat treatment step is 850° C. to 950° C., and in the resulting barium titanate particles, a ratio (I₍₂₀₀₎I_{b}) of X-ray intensity (I_{b}) at a midpoint of peak point assigned to the (200) plane and a peak point assigned to the (002) plane to diffraction intensity I₍₂₀₀₎ assigned to the (200) plane is 4 or higher, which is measured by powder X-ray diffraction using an X-ray CuKα radiation.

5. The production method as set forth in claim 1, wherein the first heat treatment step is performed under a pressure between 1×10³ and 1.0133×10⁵ Pa at a temperature of 575° C. to 650° C. in the air, and 25 wt % or more but not more than 55 wt % of the mixed powder becomes barium titanate.

6. The production method as set forth in claim 1, wherein the first heat treatment step is performed under a pressure between 1×10³ and 1.0133×10⁵ Pa at a temperature of 600° C. to 700° C. in the air by using a firing furnace for firing powder substance while fluidizing it, and 20 wt % or more but not more than 75 wt % of the mixed powder becomes barium titanate.

7. The production method as set forth in claim 5, wherein a CO₂ gas concentration in the atmosphere is controlled to 15 mole % or lower in the first heat treatment step.

8. The production method as set forth in claim 5, wherein a step of cooling to 550° C. is performed after the first heat treatment step and before performing the second heat treatment step.

9. The production method as set forth in claim 1, wherein the first heat treatment step is performed under a pressure of 1×10³ Pa or lower at a temperature of 450° C. to 600° C.

10. The production method as set forth in claim 1, further comprising a step for confirming progress of the first heat treatment step by evaluating weight concentration of a barium titanate phase by conducting a powder X-ray diffraction analysis on a product of the first heat treatment step,

11. The production method as set forth in claim 1, further comprising a step for confirming progress of the first heat treatment step by observing a product of the first heat treatment step through a transmission electron microscope analysis, and confirming a barium titanate phase on surfaces of titanium dioxide particles.

12. The production method as set forth in claim 2, wherein a heat treatment temperature in the second heat treatment step is 850° C. to 950° C., and a c/a value of barium titanate particles to be generated is 1.008 or larger.

13. The production method as set forth in claim 2, wherein a heat treatment temperature in the second heat treatment step is 850° C. to 950° C., and in the resulting barium titanate particles, a ratio (I₍₂₀₀₎I_{b}) of X-ray intensity (I_{b}) at a midpoint of peak point assigned to the (200) plane and a peak point assigned to the (002) plane to diffraction intensity I₍₂₀₀₎ assigned to the (200) plane is 4 or higher, which is measured by powder X-ray diffraction using an X-ray CuKα radiation.

14. The production method as set forth in claim 3, wherein a heat treatment temperature in the second heat treatment step is 850° C. to 950° C., and in the resulting barium titanate particles, a ratio (I₍₂₀₀₎I_{b}) of X-ray intensity (I_{b}) at a midpoint of peak point assigned to the (200) plane and a peak point assigned to the (002) plane to diffraction intensity I₍₂₀₀₎ assigned to the (200) plane is 4 or higher, which is measured by powder X-ray diffraction using an X-ray CuKα radiation.

15. The production method as set forth in claim 12, wherein a heat treatment temperature in the second heat treatment step is 850° C. to 950° C., and in the resulting barium titanate particles, a ratio (I₍₂₀₀₎I_{b}) of X-ray intensity (I_{b}) at a midpoint of peak point assigned to the (200) plane and a peak point assigned to the (002) plane to diffraction intensity I₍₂₀₀₎ assigned to the (200) plane is 4 or higher, which is measured by powder X-ray diffraction using an X-ray CuKα radiation.

16. The production method as set forth in claim 6, wherein a CO₂ gas concentration in the atmosphere is controlled to 15 mole % or lower in the first heat treatment step.

17. The production method as set forth in claim 6, wherein a step of cooling to 550° C. is performed after the first heat treatment step and before performing the second heat treatment step.
